(19) United States
(12) Patent Application Publication
(10) Pub. No.: US 2002/0115453 A1
(43) Pub. Date: Aug. 22, 2002

(54) Method and system for location based wireless communication services

(76) Inventors: Ronald Leon Poulin, Victoria (CA); Kevin Thomas Buckham, Victoria (CA); Anthony Luigi Melli, Vietoria (CA)

Correspondence Address: MARSH, FISCHMANN & BREYFOGLE LLP, 3151 SOUTH VAUGHN WAY, SUITE 411, AURORA, CO, 80014, US

(21) Appl. No.: 10/077,572

(22) Filed: Feb. 15, 2002

Related U.S. Application Data
(60) Provisional application No. 60/269,506, filed on Feb. 16, 2001.

(51) Int. Cl. H04Q 7/20

(52) U.S. Cl. 455/456; 455/457; 455/435

(57) ABSTRACT

Location based wireless services and service center that provides map-serving, wireless device tracking, navigation, messaging, business, entertainment, and meeting services based on the location of wireless devices. The wireless service center comprises a processing system coupled to an interface system. The processing system is configured to provide the map-serving, wireless device tracking, navigation, messaging, business, entertainment, and meeting services based on the location of wireless devices. The interface system is configured to exchange service related information and messaging between the processing system and the wireless devices using the communication services.

### CROSS REFERENCE TO RELATED APPLICATIONS

This application claims priority under 35 U.S.C. §119 to prior U.S. Provisional Patent Application Serial No. 60/269,506 filed Feb. 16, 2001, the entirety of which is hereby incorporated by reference.

### FIELD OF THE INVENTION

The invention is related to the field of wireless communication services, and in particular, to a method and system for providing location based wireless communication services for grouping and linking proximately located wireless subscribers.

### BACKGROUND OF THE INVENTION

The development of wireless communication services has taken on critical importance with the dramatic rise in consumer usage. With the proliferation of the Internet, new types of services, such as web browsing, PUSH technologies, and email, have joined the array of already existing services. One example of a new variety of wireless services is location based services.

Location based services focus on the problem of providing value-added services to subscribers based on the location of a wireless device within a wireless network. According to one type of location based wireless service, subscribers obtain information on businesses located in the vicinity of the wireless device. As subscribers move throughout the wireless network with their wireless device, they may enter requests for location information related to particular types of businesses. The requests for the location of the wireless device are processed in the Gateway Mobile Location Center or another network platform to determine the location area, cell identity with geographical coordinates or the like, of the requesting wireless device. The device location information is provided to a relational database that identifies businesses located within or near the location of the wireless device and provides the business location information to the wireless device. In some cases, the service provider may use information provided by the subscriber to provide the business location information to the device. For example, a subscriber could specify certain preferred business, such as a preferred hotel chain. When the location request is received, the subscriber information is used to retrieve and provide information about the preferred hotels matching the subscriber's information.

### SUMMARY OF THE INVENTION

In view of the foregoing, a primary object of the present invention is to provide a location based service center that provides a suite of location based wireless communication services. Another object of the present invention is to permit wireless subscribers to define one or more groups that the subscriber may receive certain information on, such as location and status of subscribers within a group. Another object of the present invention is to provide business, entertainment, and meeting services based on the location of wireless devices relative to one or more of a plurality of pre-defined service areas.

In carrying out the above objects, and other objects, features, and advantages of the present invention, a first example of a communication service is provided, which permits subscribers to define and maintain lists of wireless devices for which a subscriber may request location and status information. For example, the present service may be utilized in an employment environment to permit employers to track progress and manage workloads by providing an overall picture of employee location and permitting employees to provide job status information back to employers as work progresses. In another example, the present service may be utilized in a social environment to permit friends, family, and any other desired grouping, e.g. members of a club, members of a church group etc., to obtain location and status information from other members of the group. As referred to herein, the subscriber status is an indication of a present state of the subject subscriber that is provided by the subject subscriber's wireless device, which in turn receives the status indication from the subject subscriber. For example, when the present service is used in an employment environment, subscriber status may include without limitation, “arrived,” “off-duty,” “en-route,” etc. When the present service is used in other environments, such as a social or family environment, the subscriber status may include without limitation, “in school,” “at work,” “do not disturb,” “call me,” “bored . . . ,” etc.

In this regard, for example, the service may permit subscribers to obtain the location and status of other subscribers using secure web-based map display. Alternatively, subscribers may obtain other subscriber location and status information using a web browser provided on the subscriber's wireless device. Various refinements exist of the features noted in relation to the subject communication service of the present invention. Further features may also be incorporated as well. These refinements and additional features may exist individually or in any combination. Thus, according to one feature, subscribers may exchange communications with other subscribers in their group via text messages provided over the web-based map display or their wireless device. This in turn provides numerous other features and advantages such as permitting subscribers to provide navigation information to other subscribers as well as various other communications for employment related and/or social interaction.

In another example of a communication service, subscribers are provided with business, entertainment, and meeting services based on the location of a wireless device relative to one of a plurality of pre-defined service areas. In this case, the location of the wireless device is provided based on pre-defined service areas that are independent of a communication network. Further, in this regard, the service may also provide information about other subscribers who are proximately located to a requesting subscriber and link proximately located subscribers for business or social interaction.

Specifically, upon registering for the service; subscribers provide user information that is used to generate and store a subscriber profile. Upon activation of the service, a subscriber is provided with information about a pre-defined service area that the subscriber is located in or proximately located to. The subscriber is also provided with information about locations, events, attractions, and/or points of interest located in the service area. In some examples of the invention, the subscriber is also provided with information about other active subscribers proximately located to the subscriber or the same service area. The information about the other active subscribers could be the profile information for the other active subscribers or could be location information for the other active subscribers. It should be noted that this service differs from the above-described service, in that the subscribers may not be previously known to each other, such as is the case in the groupings of the previous service, but rather are linked only through subscription to the service and location in one of the service areas.

In the context of the present invention, the pre-defined service areas are defined as villages. The information about the pre-defined service areas or villages is defined as service area information. The information about locations, events, attractions, and/or points of interest located in a pre-defined service area is defined as venue information. The information about other subscribers proximately located to a requesting subscriber or service area is defined as subscriber information.

Various refinements exist of the features noted in relation to the subject communication service of the present invention. Further features may also be incorporated as well. These refinements and additional features may exist individually or in any combination. Thus, according to one feature, the venue information provided to the subscriber could be customized for the subscriber based on either the subscriber's profile, the location of the requesting wireless device, the time of day, or the season that a subscriber is located in a particular service area. According to another feature, the subscriber information may be customized based on the subscriber profile to match subscribers with similar profile information (e.g. interests or age groups) for business or social interaction. According to yet another feature, subscribers may be provided with contact information for other proximately located subscribers having interesting profile information or who are located at or near the same venue event or attraction of interest.

The present location based wireless services are provided by one or more location based wireless service centers, comprising a processing system coupled to an interface system. The processing system is preferably configured to provide map-serving, tracking, navigation, messaging and other features of the present communication services. For example with regard to the above-described business, entertainment, and meeting services, the processing system may process service activation request messages from wireless devices to activate the service. Responsive to activating the service, the processing system may automatically determine the location of a requesting device relative to one of the plurality of pre-defined service areas (villages) and generate a response message for the requesting device that causes the device to display at least one of the service area information (information on the villages), the venue information (information on events attractions within a village), and/or the subscriber information (information on other subscribers located in a village or proximate to the village). The interface system is configured to receive the service activation request messages for the processing system and provide the response messages to the wireless devices.

### BRIEF DESCRIPTION OF THE DRAWINGS

The same reference number represents the same element on all drawings.

FIG. 1 illustrates an example of a location based service center according to the present invention;

FIG. 2 is a flow chart illustrating an example of the operation of the location based service center according to the present invention;

FIG. 3 illustrates an example of a device architecture for the location based service center according to the present invention;

FIG. 4 illustrates an example of a network architecture for the location based service center according to the present invention;

FIG. 5 is a message sequence chart illustrating another example of the operation of the location based service center;

FIG. 6 is another message sequence chart illustrating another example of the operation of the location based service center; and

FIG. 7 is another message sequence chart illustrating another example of the operation of the location based service center.

### DETAILED DESCRIPTION

The present location based wireless services and location based service center provide subscribers with a variety of information based on the location of wireless devices. In one embodiment of a communication service, the location based service center permits subscribers to obtain other subscriber locations and other subscriber status using secure web-based map display. Alternatively, subscribers may obtain other subscriber locations and status using a web browser provided on the subscriber's wireless device. As referred to herein, the subscriber status is an indication of a present state of the subject subscriber that is provided by the subject subscriber's wireless device, which in turn receives the status indication from subject subscriber. For example, when the present service is used in an employment environment, subscriber status may include without limitation, “arrived,” “off-duty,” “en-route,” etc. When the present service is used in other environments, such as a social or family environment, the subscriber status may include without limitation, “in school,” “at work,” “do not disturb,” “call me,” “bored . . . ,” etc.

In this regard, the communication service permits subscribers to define groups of wireless devices for which a subscriber may request location and status information. In other words, a subscriber may create and maintain a list(s) of wireless devices for which the subscriber may request permission and is authorized to obtain location and status updates. For example, the present service may be utilized to permit employers to track progress and manage workloads by providing an overall picture of employee location, permitting employees to provide their current status, and permitting employers and employees to communicate via short message service or otherwise. In another example, the present service may be utilized in a social environment to permit friends, family, and any other desired grouping, e.g. members of a club, members of a church group etc., to obtain location and status information from other members of the group and to communicate with other members using short messages.

The communication service also permits subscribers to maintain a profile that defines permission on when, where, and how other authorized subscribers (members of the group) may obtain an individual subscriber's own location and status information. For example, permission may be granted according to a time of day, day of the week, e.g. Monday-Friday from 4:00 PM-1:00 AM or always. Permission may also be granted within a specified geography, e.g. city, county, country or arbitrary subscriber defined area.

As an override to existing rules contained in the subscriber's profile, the communication service also permits the subscriber to globally turn ON or turn OFF permission to be located and statused. The communication service may also permit subscribers to send short text messages to one or more of the located wireless devices. Through the web based browser subscribers are also provided with basic management access to the service. For example, a subscriber may manage his/her profile information to change defined permissions or modify group listings to add or remove subscribers from a group. In another example, the subscriber may also calendar events for future notifications to members of the subscriber's group. For example, a subscriber may calendar a future event that triggers at the event time a short message to subscriber's within the group, e.g. “It is Grandmother's birthday tomorrow—don't be late for dinner.” In another example, proximity triggers may be set so that a short message or other alert is sent to a subscriber's wireless device or a notification is provided within the Internet session. For example, a notification of close proximity of subscribers within a group, or a notification that a wireless device enters/exits a specified geographic zone or area may be provided.

In another embodiment of a communication service, the location based service center may provide subscribers with a variety of information based on the location of the subscriber's wireless device relative to one of a plurality of service areas that are pre-defined independent of a communication network. The pre-defined service areas are defined herein as villages. The villages are pre-defined based on criterion independent of a communication network. For example, villages may be defined based on events, activities, and locations (the venue items) within a specific geographic area. Thus, a village could be any area that includes at least one venue item. Examples of villages could include without limitation, a city, a national park, a town, or a portion of the city, town or national park. To clarify, one example of a village could be an old town portion of a city that includes the major sights, bars, restaurants, and nightlife. Another example of a village could be the historical section of the city that includes one or more historical points of interest. In other words, a city or geographic area may include one or more villages arbitrarily defined independent of the communication network serving the village area. The venue items could be any, location, event, attraction or point of interest. Some examples of venue items could include without limitation, merchant locations, historical attractions, and establishments such as bars, nightclubs, restaurants, shops etc.

Advantageously, customers may subscribe to the service using their wireless device or an Internet connection with a web site. Typically the web site is hosted by the service provider, but may be hosted and operated by a third party vendor. During subscription, subscribers are prompted for and provide user information. Similar to the above embodiment, in this embodiment the user information is stored in a profile and is defined herein as profile information. The profile information is used by the location based service center to create a subscriber profile. It will also be appreciated that the same subscriber profile may be utilized to provide any of the communication services described herein. In this embodiment, the profile information could be any information useful in personalizing the service, identifying and providing venue information and/or subscriber information. For example, the subscriber profile may be utilized to suggest villages that are proximate to the subscriber and that the system determines may be of interest to the subscriber based on the subscriber's profile information.

Subscribers are given the option of whether or not their profile information is provided to other subscribers. Thus, the profile information provided by the subscribers could vary as a function of how an individual subscriber desires to use the service. For example, a subscriber who desires to use the service to meet other people with similar interests (typically requiring the subscribers profile to be provided to other active subscribers) may provide a first set of profile information tailored for that purpose.

Other subscribers who only desire to use the service to retrieve the service area and venue information, which typically does not require subscriber profile information be provided to other subscribers, may provide a second set of profile information tailored for that purpose. The location based service center manages the subscriber profiles, and in some cases, uses the profiles to provide different service area, venue, and subscriber information to an active subscriber.

The present service is designed to provide fun finding meeting areas and venues where subscribers can spontaneously meet, or plan to meet, with other subscribers. The service may also serve as an introductory meeting service for subscribers interested in a casual date or impromptu meeting. Subscribers use their wireless devices such as telephones, personal data assistants, and notebook computers to obtain the service area information, venue information, and subscriber information. Active subscribers may also communicate with other active subscribers using their wireless devices by sending short messages or placing voice calls. It should be noted that the contact information for other active subscribers is provided as part of the subscriber information, which subscribers have consented too, so that subscribers can feel comfortable sending a short message or placing a voice call to other active subscribers, which they may not previously have known. Advantageously, the present service provides subscribers with access to information on villages that they are located in or proximately located too as well as events, attractions and other subscribers located in or near the same village.

The present service is activated by a service activation request message provided by a subscriber's wireless device. The service activation request message could be a special function button on the wireless device that provides a unique service activation signal to the location based service center. The service activation request message could also be the call signaling generated when a subscriber calls a service activation number. The service activation request may also be provided over the Internet using an Internet service provided to the subscriber's wireless device.

In one example of the invention, once activated, the service is provided to subscribers for a pre-determined period of time. At the expiration of the pre-determined time period, the service center queries the subscriber's wireless device to determine if the subscriber desires to continue using the service or sign-off. The service center processes a response message from the wireless device to either sign-off the subscriber, or continues providing the service, depending on the indication provided by the subscriber. Subscribers are also permitted to request sign-off at any time during the predetermined time period as a matter of choice.

In another example of the present invention, the service period ends once the service area information, venue information, and subscriber information is provided to the requesting device. To reactivate the service requires another service activation request message from the subscriber's wireless device.

Upon activation of the service, subscribers are provided with information on at least one village that the subscriber is located in, or proximate too. The information includes at least a description of the village, including the village name, as well as venue information about the venue items located within the village. In some examples of the present service, the venue items are customized for the subscriber based on the available venue items within a village that match the subscriber's profile information. For example, a subscriber who indicates in the profile information a desired type of activity would receive information related to the availability of that activity within the village the subscriber is located in upon service activation. In another example of the service, the venue items are provided to the subscriber based on the available venue items and the time of day the service is activated. For example, if the service is activated around the noon hour of the day the venue items provided to the subscriber could include a list of lunch locations within a village. In yet another example of the present service, the venue items are provided based on the season that a subscriber is located in a specific village. For example, different venue items could be provided during the summer, winter, spring, and fall months as a function of when a subscriber is located in a village and the activities available in that village. Additionally, the venue items could be updated during the course of the service period to provide venue items to an active subscriber based on the time of day. For example, if a venue item is closed or unavailable when a subscriber activates the service, but later becomes available, updated venue information is provided to the subscriber.

In yet another example of the service, information on other active subscribers proximately located too or in the same village is also provided to the subscriber upon service activation. The information on the other active subscribers could include the number of other active subscribers currently in or near the same village as the subscriber. The information may also include profile information on the other active subscribers. Additionally, the profile information on the other active subscribers could be selectively provided based on a requesting subscriber's own profile information to permit social and/or business interaction between active subscribers who share similar interests or are in the same age group. Additionally, the subscriber information is updated during the service period to provide information on newly activating subscribers proximately located to or in the same village as an active subscriber.

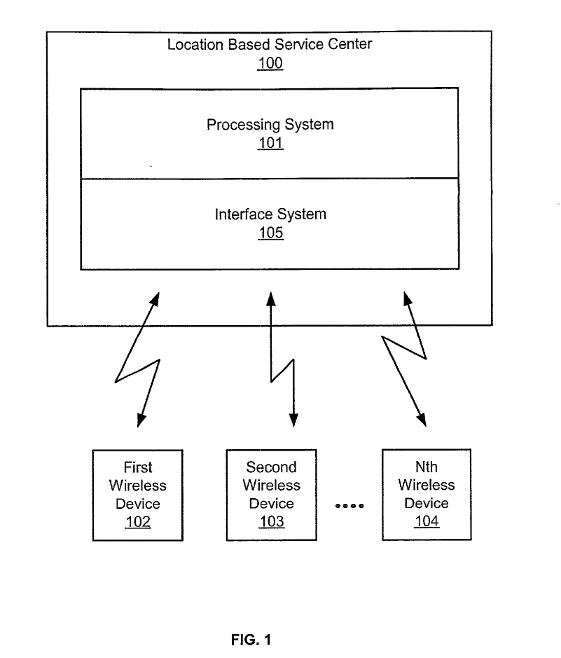

### Location Based Service Center-FIG. 1

FIG. 1 depicts a location based service center (“LBSC”) 100 according to the present invention and a plurality of wireless devices 102-104. The LBSC 100 comprises a processing system 101 coupled to an interface system 105. Those skilled in the art will appreciate that the LBSC 101 could reside in a proprietary network or a public network, such as a data or telephony network, as a matter of design choice.

The processing system 101 could be any processor or group of processors configured to provide map-serving, wireless device tracking, navigation, messaging, and other features of the present communication services. For example, the processing system 101 may access other network components such as location finding equipment to determine the location of the wireless devices 102-104. In this regard, the processing system 101 may process service activation request messages from subscribers using the wireless devices, 102-104, to automatically determine the location of the requesting wireless device, e.g. 102, relative to one of the above-described villages, and generate a response message that includes at least one of the service area information, the venue information, and the subscriber information based on the location of the requesting device 102 relative to one of the villages. Further, the processing system 101 may determine the location of the wireless devices 102-104 in response to a request received over a web-browser and provide the location along with the status of the owner of the wireless devices 102-104 relative to a map display back to the web browser.

In some examples of the present invention, the processing system 101 also receives and manages the profile information for subscribers of the communication service. In another example of the invention, the processing system 101 provides profile information for active subscribers within a village to other active subscribers in the same village. In another example of the present invention, the processing system 101 processes the profile information for an individual subscriber to provide customized venue information based on the location of the subscriber and the subscriber's profile information. Finally, the processing system 101 supports other features that will become apparent from the following description.

The interface system 105 could be any device or group of devices configured to receive the service activation request messages for the processing system 101 and provide the response messages to the wireless devices 102-104. The interface system 105 could also receive the profile information for the processing system 101 and provide the profile information to other active subscribers. Finally, the interface system 105 also supports other features that will become apparent from the following description.

The wireless devices, 102-104, could be any wireless devices configured to exchange information over a wireless network. Some examples of the wireless devices, 102-104, include without limitation, conventional wireless telephones, personal data assistants, and notebook computers.

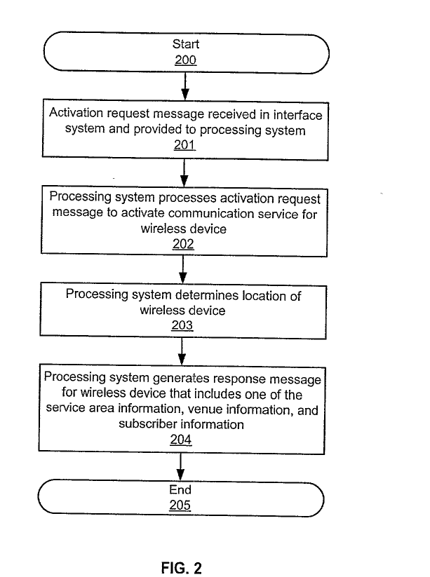

### Operation FIG. 2

FIG. 2 is a flow chart illustrating an example of the operation of the LBSC 100. On FIG. 2 the operation begins at step 200. At step 201, an activation request message is received in the interface system 105 and provided to the processing system 101. The activation request message is provided by one of the wireless devices 102-104, in this example the device 102. At step 202, the processing system 101 processes the activation request message to activate the communication service for the device 102. At step 203, the processing system determines the location of the wireless device 102 relative to one of the villages. Those skilled in the art will appreciate that there are many documented methods for determining the location of a wireless device. For example, the processing system 101 could determine the location of the wireless device 102 using internal processing circuitry and a conventional method. Alternatively, the processing system 101 could use other location finding equipment in a network to determine the location of the device 102. In either case, the current location of the wireless device 102 is indexed against a plurality of pre-defined service areas to determine the location of the device 102 relative to one of the pre-defined service areas or villages.

At step 204, the processing system 101 generates and provides a response message to the wireless device 102. The response message causes the device 102 to display one or more of the service area information, the venue information, and the subscriber information. For example, the response message could cause the device 102 to display the following message: “You are in the XYZ village, which includes A, B, C, and D venues for your enjoyment.” As will become apparent from the following description, the response message could also include information on other active subscribers in the XYZ village or proximately located to the XYZ village. Additionally, the response message could be provided as a voice message as well as the above described text message. The operation ends ate step 205.

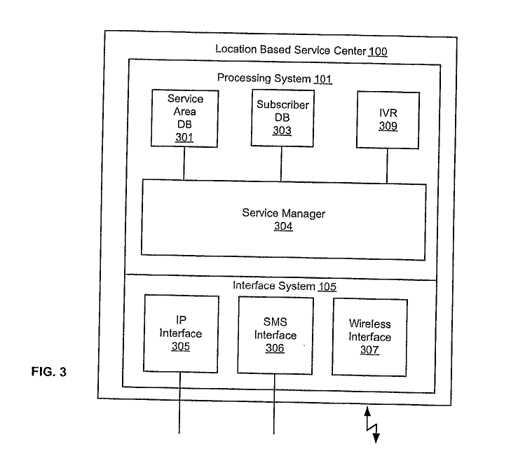

### System Architecture For LBSC-FIG. 3

FIG. 3 depicts one example of a device architecture for the LBSC 100 according to the present invention. The processing system 101 comprises a service manager 304, connected to a service area database 301, a subscriber database 303, and an interactive voice response unit (“IVR”) 309.

The service manager 304 is a processing platform configured to interact with other network elements and internal components to provide the map-serving, wireless device tracking, navigation, messaging, and other features of the present communication services. The service manager 304 may also permit multiple wireless location technologies to interoperate. In that regard, service manager 304 may provide a link between location finding technologies, wireless networks and wireless location applications to form the most accurate location for each wireless device within a network.

For example, in the context of the business, entertainment, and meeting service, the service manager 304 receives service activation request messages from the wireless devices, 102-104, and processes the service activation request messages to activate the communication service and determine the location of the requesting device, e.g. device 103. The service manager 304 also interacts with the service area database 301 to index the current location of the requesting device, e.g. device 103, to obtain the location of the requesting device relative to one of the pre-defined service areas or villages. The service manager 304 also interacts with the service area database 301 to retrieve the service area information and venue information for the village that a requesting device is located in or proximately located too.

The service manager 304 also receives the profile information from a subscriber and interacts with the subscriber database 303 to create the subscriber profiles. The service manager 304 also interacts with the subscriber database 303 to obtain subscriber profile information to provide to other active subscribers. In the case of customized venue information, the service manager 304 could use profile information for a requesting subscriber to retrieve the customized venue information from the service area database 301 based on the profile information. In the case of customized profile information, the service manager 304 could use a requesting subscriber's profile to match profile information for other active subscribers and provide customized profile information to the requesting subscriber.

The voice response unit (“IVR”) 309 could be a conventional IVR configured to provide information using synthesized voice. The service manager 304 could use the IVR 309 to interact with subscribers. The interaction could be related to the registration of a subscriber or the administration of the communication service to subscribers. For example, the service manager 304 could use the IVR 309 to provide the service area information, the venue information, and the subscriber information to the wireless devices, 102-104. In another example of the present invention, the service manager 304 could use the IVR 309 to obtain the profile information from subscribers during registration for the service.

The service area database 301 could be any device or group of devices configured to manage and provide the service area information and the venue information to the service manager 304. In some examples of the invention, the service area database 301 could function as a relational database. In this case, the service area database 301 processes requests from the service manager 304 that include network location information for a wireless device to provide the location of the wireless device relative to one of the villages. Additionally, the service area database 301 could provide the service area and venue information for the village to the service manager 304 based on the location of the requesting device 104. In other examples, the service area database 301 could function as a database server that is accessed by the service manager 304 to retrieve the location of the wireless device relative to one of the villages and retrieve the service area and venue information based on the location of the requesting wireless device.

The subscriber database 303 could be any device or group of devices configured to manage the subscriber profile information and provide the subscriber profile information to the service manager 304. Similar to the service area database 301, the subscriber database 303 could function as a relational database to process profile information provided by the service manager 304 and return matching profile information on other subscribers based on the location of the subscribers. Alternatively, the subscriber database 303 could function as a database server that is accessed by the service manager 304 to retrieve the profile information from the subscriber database 303.

The interface system 105 comprises an Internet protocol interface 305, a short message service interface (“SMS”) 306, and a wireless interface 307. Those skilled in the art will appreciate that the interface system 105, could include other interfaces as a matter of design choice although only the IP interface 305, the SMS interface 306, and the wireless interface 307 are shown on FIG. 3 for clarity. The wireless interface 307 could be a conventional wireless interface that provides wireless connectivity between the service manager 304, a wireless network, and the wireless devices 102-104. The SMS interface 306 could be a conventional interface that provides short message exchange between a short message service center, the wireless devices, 102-104, and the service manager 304. The IP interface 305 could be a conventional Internet protocol interface that exchanges communications between the service manager 304 and the Internet. Additionally, in the case of Internet capable devices 102-104, the wireless interface 307 may include a wireless application protocol gateway that interfaces with wireless application protocol enabled devices and creates Internet Protocol compatible wireless markup language sessions to provide communication exchange between the service manager 304 and the wireless devices 102-104 over the Internet.

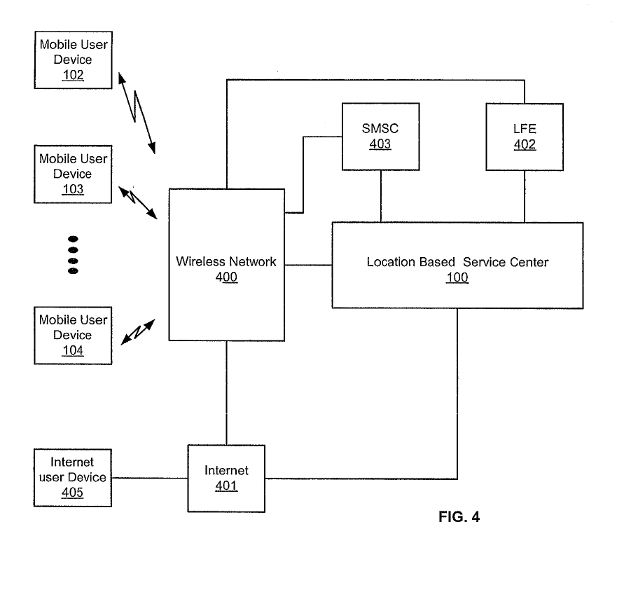

### Network Architecture FIG. 4

FIG. 4 depicts a network architecture for the LBSC 100. FIG. 4 depicts the wireless devices, 102-104, a wireless network 400, an Internet user device 405, short message service center (“SMSC”) 403, location finding equipment 402, and the LBSC 100. The Internet 401 is connected to the LBSC 100 and the Internet user device 405.

The LBSC 100 is connected to the wireless network 400, the SMSC 403 and the LFE 402.

The wireless communication network 400 could be a conventional wireless network that provides wireless communication services. Some examples of the wireless communication services include personal communications service (“PCS”), microwave multipoint distribution service (“MMDS”), millimeter wave service, code division multiple access (“CDMA”) service, and time division multiple access (“TDMA”) service.

The wireless devices, 102-104, exchange communications with the LBSC 100 over the wireless network 400 or over the Internet 401. Those skilled in the art will appreciate that the wireless network 400 and the Internet 401 would include various conventional components not shown on FIG. 4 for clarity. The Internet user device 305 exchanges communications with the LBSC 100 over the Internet 401. The Internet user device 405 could be any device configured to connect and exchange information over the Internet 401. Some examples of the Internet user device 405 include without limitation, a desktop computer, a notebook computer, and a personal data assistant.

It should be noted that the LBSC 100 could retrieve content information from the Internet 401 and provide the content information to the wireless devices, 102-104. For example, the service area database 301 and or the subscriber database 303 could be located in the Internet 401 and accessed over the IP interface 305 by the LBSC 100. In another example, the content information may be map information provisioned by the LBSC 100 to provide the web-base map display of the location and status of subscribers within a defined group. In this regard, subscribers may view a map over the Internet 401 showing icons that represent the location of wireless devices owned by other subscribers within that group. Further, in this regard, the status information for the subject subscribers may be provided on the same page or new page as the location mapping. In addition, the wireless device location icons may be made to change color or shape as a function of their reported status.

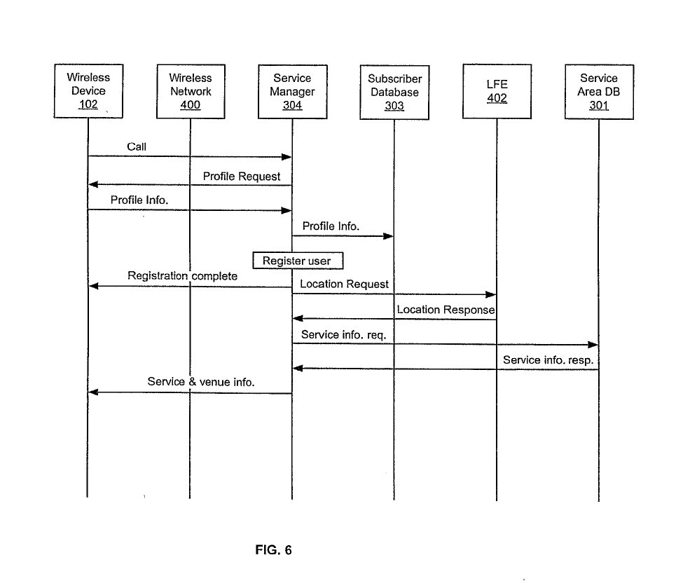

The SMSC 403 could be a conventional device that allows short text messages to be exchanged between the wireless devices 102-104 and other networks or network elements such as the LBSC 100. The LBSC 100 interacts with the SMSC 403 to exchange short message communications with the wireless devices 102-104. For example, the LBSC 100 could use the SMSC 403 to provide the service area information, the venue information, and the subscriber information to the wireless devices 102-104. In another example, the LBSC 100 could use the SMSC 403 to dynamically register a previously unregistered subscriber for the service as described below in FIG. 6. In another example of the invention, the LBSC 100 could use the SMSC 403 to provide the service area, venue and/or subscriber information to the wireless devices 102-104. The SMSC 403 could also provide short message services to the wireless devices 102-104 and permit active subscribers to communicate with other active subscribers using their wireless devices 102-104. The SMSC 403 may be a store-and-forward messaging element that will hold messages for a period until a wireless device, e.g. 102 is registered and can accept the message.

The LFE 402 could be any device or group of devices configured to determine the location of the wireless devices 102-104, and provide the location information to the LBSC 100. Examples of the LFE 402 include network based systems that determine device location based on analysis of signals communicated between network equipment and the device, e.g. cell/sector, microcell, angel of arrival, time of arrival and/or time delay of arrival systems, and external systems that determine location based on signals from external sources, e.g., Global Positioning System signals. The location information from the LFE 402 could be used by the LBSC 100 in raw form or may be processed in conjunction with other LFE information, mapping information or the like to provide enhanced location information. In that regard, the LBSC 100 may accept position updates from multiple LFE's and select the best available location updates or position updates generated by an LFE using a method of choice. The LBSC 100 may correlate data from various types of position determination equipment active in the wireless network 400, determine from the incoming location data the most accurate location of each wireless device and utilize this information to access the service area and subscriber databases 301 and 303.

In one example of the operational protocol for the LBSC 100, the LBSC 100 may compare the location information from the LFE 300 with information from the service area database 301 to determine a devices location relative to one of the pre-defined service areas or villages. For example, responsive to a service activation request message from the device 103, the LBSC 100 could query the LFE 300 for location information relating to the location of the device 103. The LBSC 100 processes the location information received from the LFE 300 to determine that the device 103 is located in the ABC village and returns a response message to the device 103 indicating to the subscriber that he/she is located in the ABC village, the ABC village includes DEF venues and has X number of active subscribers.

In another example of the LBSC 100 may be utilized to provide navigation input to a subscriber's wireless device. A typical scenario could include a subscriber accessing the web-based map-tracking and status information who receives a lost status from one of the subscribers in the group. In this case, the subscriber accessing the web site may enter a desired address into the web-based map-tracking system that is then located by the system and an icon indicating the location displayed on the web-based map. The subscriber accessing the web site may then use the SMSC 403 to provide turn-by-turn directions to the lost subscriber while tracking progress of the lost subscriber on the web-based map.

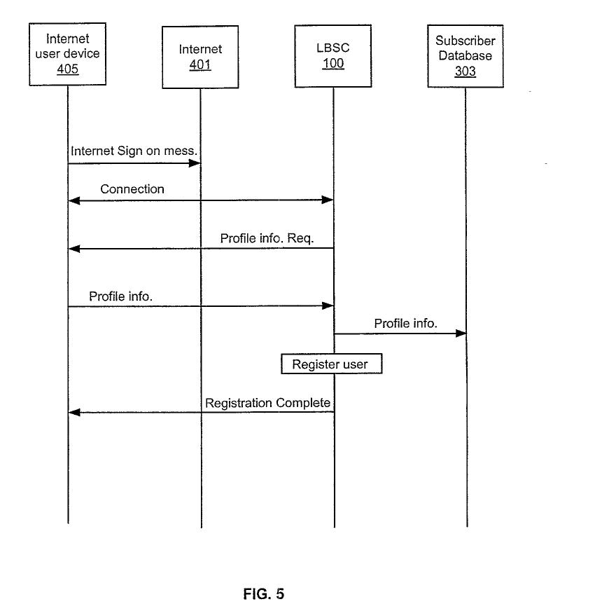

### Additional Operation FIGS. 5-7

FIGS. 5-7 Illustrate additional examples of the location based wireless service and the operation of the LBSC 100. Those skilled in the art will appreciate numerous variations that do not depart from the present invention. Those skilled in the art will also appreciate that various features described below could be combined together with the above described embodiments to form multiple variations of the invention.

FIG. 5 is a message sequence chart depicting an example of an Internet registration process for the present location based wireless service. On FIG. 5 an Internet sign on message is provided by the Internet user device 405 to establish a connection with the LBSC 100 over the Internet 401. Those skilled in the art will appreciate that the connection could be a conventional connection to the LBSC 100 over the Internet 401 using an Internet browser and Internet service provider. Those skilled in the art will also appreciate that the Internet connection to the LBSC 100 could be provided using conventional devices such as an Internet server connected to or located in the LBSC 100.

Responsive to establishing the Internet connection, profile information is requested from the user and provided by the user to the LBSC 100 over the Internet 401. The requested profile information could vary as a matter of design choice. Some examples of the profile information could include without limitation, a subscriber name or alias, gender, age, languages, and interests such as travel, outdoors, music, literature, dining, dancing and sailing. Those skilled in the art will recognize numerous other examples of profile information that could be requested according to the principles of the present invention. In another example of the present invention, the user could be screened to determine what the user is looking for in the communication service. For example, some subscribers may prefer only to use the service to obtain the service area information and the venue information and may not wish to receive subscriber information or have their own information provided to other subscribers. In this case the requested profile information may be limited to information required to provide the customized venue information to the user. Other subscribers, on the other hand, may desire to use the service to meet and interact with other service. subscribers. In this case the requested profile information may include more personal questions such as interests, age, and gender.

Upon receiving the profile information, the service manager 304 provides the profile information to the subscriber database 303 and a subscriber profile is created in the subscriber database 303. The service manager 304 also registers the subscriber for the wireless service. The registration process could be any process representative of identifying the subscriber's wireless device as a registered device to the LBSC 100. In one example of the registration process, the subscriber's wireless telephone number is requested and used to identify a mobile service identification number (“MSIDN”) associated with the subscriber's wireless device. The MSIDN is then identified or entered in the logs of the service manager 304 and indicated in the logs as a registered device.

Responsive to completing the profile creation and registration process, the service manager 304 provides a registration complete message over the Internet 401 to the Internet user device 405. The registration complete message indicates that the user is now registered with the location based service center 100 and may use the communication service. The registration complete message may also include additional information such as instructions on using the service and/or service access numbers.

FIG. 6 is a message sequence chart illustrating an example of a dynamic registration process according to the present invention. Advantageously, the dynamic registration process of FIG. 6 permits a previously unregistered subscriber who shows up in a village and learns of the service to immediately register and use the service.

On FIG. 6 the operation begins with a call received in the LBSC 100 from a wireless device, e.g. 102, over the wireless network 400. The call is placed to a designated service number that terminates at the service manager 304. Responsive to receiving the call, the service manager 304 identifies the calling device 102 to determine if the device 102 is known or registered with the LBSC 100. Those skilled in the art will recognize numerous methods of identifying the device 102 with one example including the use of the MSIDN.

In this case, the service manager 304 determines that the device 102 is not registered with the LBSC 100 and processes the call to provide a profile request message to the device 102. The profile request message could be a voice message provided using the IVR 309 or could be a short text message using the SMSC 403. Responsive to the profile information request message, the profile information is provided to the service manager 304 using the wireless device 102. The service manager 304 processes the profile information to register the device 102 and activates the communication service. In some examples of the present invention, the requested profile information could be an abbreviated profile received for the purpose of registering the device 102 with the LBSC 100. In this case, the subscriber would be prompted to provide additional profile information via the Internet registration process of FIG. 5 at a later date. The service manager 304 also creates a subscriber profile in the subscriber database 303 using a profile information message. Responsive to completion of the profile creation and registration process, the service manager 304 provides a registration complete message to the device 102 to indicate completion of the registration process.

The service manager 304 also provides a location request message to the LFE 402. The LFE 402 processes the location request message to provide a location response message that includes location information for the device 102. Responsive to receiving the location information, the service manager 304 provides a service information request message to the service area database 301 that includes the location information. The service area database 301 processes the request to index the location information against the plurality of pre-defined services areas to generate and provide a response message that includes the location of the device 102 relative to one of the villages. The service information response message also includes the service area information and venue information for the village associated with the current location of the device 102. The service manager 304 provides the service area and venue information to the wireless device 102. It should be noted that the above registration could also be accomplished in a similar manner over the Internet 401 using an Internet configured wireless device.

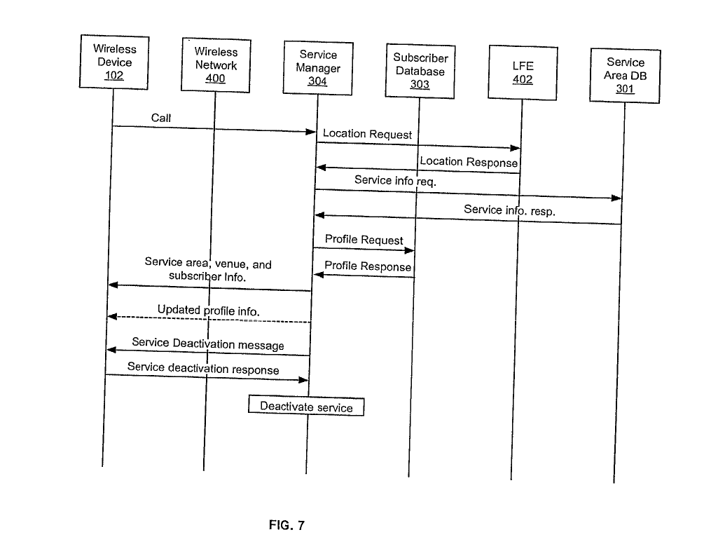

FIG. 7 is a message sequence chart illustrating another example of the wireless service according to the present invention. On FIG. 7 the operation begins with the subscriber placing a call using the wireless device 102 over the wireless network 400. The call is placed to a designated service number that terminates at the service manager 304. As noted above, the call could be generated by a special function button or code entered into the device 102.

Responsive to receiving the call, the service manager 304 identifies the calling device 102 to determine if the device 102 is known or registered with the LBSC 100. In this example the service manager 304 identifies the device 102 as registered with the LBSC 100, and processes the call to generate a location request message for the LFE 402. The LFE 402 processes the location request message to provide a location response message that includes the location of the device 102. Responsive to receiving the location information, the service manager 304 provides a service information request message to the service area database 301 that includes the location information. The service area database 301 processes the request to index the location information against the plurality of pre-defined services areas and provide a response message that includes the location of the device 102 relative to one of the villages, the service area information, and the venue information to the service manager 304.

Responsive to receiving the service area response message, the service manager 304 provides a profile request message to the subscriber database 303. The profile request message includes a request for the requesting subscriber's profile information and profile information for other active subscribers located in the same village as the device 102. The subscriber database 303 processes the profile request message to generate and provide a profile response message for the service manager 304 that includes the requesting subscriber's profile information and profile information for other subscribers in the same village.

Responsive to receiving the profile information the service manager 304 provides a message to the wireless device 102 that causes the device 102 to display the service area, venue, and subscriber information. For example the wireless device 102 could display the message “Welcome to ABC's fun finding and meeting services. You are in the XYZ village where there are currently X active subscribers having the following similar profiles: This village includes the following venues:”

Upon receiving the service area information, the requesting subscriber could visit the venue locations or use the other active subscriber profile information to contact the other active subscribers using a voice call or a short message service.

As other subscribers activate the service, the service manager 304 provides updated profile information to the wireless device 102 as indicated by the dashed line on FIG. 7. The updated profile information could be profile information on all newly activated subscribers located in the same village or just profile information on newly activated subscribers in the same village with similar profiles. After a pre-determined period of time, the service manager 304 provides a service deactivation message to the device 102. For example, the service deactivation message could cause the device 102 to display the message “Service activation time is now three hours, press 1 to continue the service or 2 to sign-off.” The service manager 304 processes the response from the wireless device 102 to deactivate or continue providing the service as a function of the indication by the subscriber. In this case the service is deactivated and no additional information is provided to the device 102.

The above-described elements can be comprised of instructions that are stored on storage media. The instructions can be retrieved and executed by a processing system. Some examples of instructions are software, program code, and firmware. Some examples of storage media are memory devices, tape, disks, integrated circuits, and servers. The instructions are operational when executed by the processing system to direct the processing system to operate in accord with the invention. The term “processing system” refers to a single processing device or a group of inter-operational processing devices. Some examples of processing systems are integrated circuits and logic circuitry. Those skilled in the art are familiar with instructions, processing systems, and storage media.

Those skilled in the art will, appreciate variations of the above-described embodiments that fall within the scope of the invention. As a result, the invention is not limited to the specific examples and illustrations discussed above, but only by the following claims and their equivalents.

We claim:

1. A method for providing a location based wireless communication service, the method comprising:
receiving a service activation request regarding a first subscriber using a wireless device;
determining in relation to the service activation request the location of the wireless device relative to one of a plurality of pre-defined service areas that are independent of a communication network; and
providing, for the wireless device, at least one of service area information, venue information, and subscriber information based on the location of the wireless device relative to the one of the plurality of pre-defined service areas.

2. The method of claim 1 the method comprising:
processing the service activation request message to activate the communication service for the first subscriber.

3. The method of claim 1 the method comprising:
processing the service activation request message to determine if the wireless device is registered for the location based wireless service; and
if the wireless device is not registered, automatically registering the wireless device for the location based wireless service.

4. The method of claim 3 the method comprising:
prior to receiving the service activation request message, registering the first subscriber for the location based wireless service.

5. The method of claim 4 wherein registering the wireless device comprises:
receiving user information from the first subscriber;
creating a first subscriber profile based on the user information; and
recording the wireless device as a registered device in a location based service center.

6. The method of claim 5 wherein the service area information comprises information on at least one of the plurality of pre-defined service areas.

7. The method of claim 6 wherein the subscriber information comprises information on other active subscribers proximately located to the first subscriber.

8. The method of claim 7 wherein the subscriber information comprises information on the other active subscribers located in one of the plurality of pre-defined service areas.

9. The method of claim 8 the method comprising:
generating the subscriber information based on the first subscriber profile to provide subscriber information on other active subscribers having similar profiles.

10. The method of claim 8 the method comprising:
providing updated profile information to the wireless device comprising information on newly activated subscribers proximately located to the first subscriber.

11. The method of claim 7 wherein the venue information comprises at least one of events and locations in one of the plurality of pre-defined service areas.

12. The method of claim 7 the method comprising:
generating customized venue information comprising at least one of events and locations in the one of the plurality of pre-defined service areas that are generated based on the first subscriber profile; and
providing the customized venue information to the wireless device.

13. The method of claim 12 the method comprising:
generating the customized venue information comprising at least one of events and locations in one of the plurality of pre-defined service areas that are generated based on a time of day.

14. The method of claim 12 the method comprising:
generating the customized venue information comprising at least one of events and locations in the one of the plurality of pre-defined service areas are generated based on a season of the year.

15. The method of claim 1 the method comprising:
after a pre-determined period of time, providing a deactivation message to the wireless device;
receiving a deactivation response message from the wireless device that includes one of a sign-off indication and a continue service indication;
in response to receiving the sign-off indication in the deactivation response message, processing the deactivation response message to stop providing the location based wireless communication service to the wireless device; and
in response to receiving the continue service indication in the deactivation response message, continue providing the location based wireless communication service to the wireless device.

16. A location based service center (“LBSC”) for providing a location based wireless communication service comprising:
a service manager configured to process a service activation request message from a first subscriber using a wireless device to determine the location of the wireless device relative to one of a plurality of pre-defined service areas that are independent of a communication network, and generate a response message that includes at least one of service area information, venue information, and subscriber information that is based on the location of the wireless device relative to the one of the plurality of pre-defined service areas; and
an interface system configured to receive the service activation request message for the service manager and transmit the response message to the wireless device.

17. The LBSC of claim 16 wherein the service manager is configured to process the service activation request message to activate the communication service for the wireless device.

18. The LBSC of claim 16 comprising:
a subscriber database configured to provide the subscriber information to the service manager, wherein the subscriber information comprises information on other active subscribers.

19. The LBSC of claim 18 wherein the subscriber information comprises profile information on the other active subscribers.

20. The LBSC of claim 19 wherein the profile information on the other active subscribers is generated based on a first subscriber profile.

21. The LBSC of claim 20 comprising:
a service area database configured to provide the venue information to the service manager, wherein the venue information comprises at least one of events and locations in one of the plurality of pre-defined service areas.

22. The LBSC of claim 21 wherein the at least one of events and locations are generated for the first subscriber based on the first subscriber profile.

23. The LBSC of claim 21 wherein the at least one of events and locations are generated for the first subscriber based on a time of day the first subscriber is located in one of the plurality of pre-defined service areas.

24. The LBSC of claim 21 wherein the at least one of events and locations are generated for the first subscriber based on a season the first subscriber is located in one of the plurality of pre-defined service areas.

25. The LBSC of claim 20 wherein the service area information comprises information about at least one of the plurality of pre-defined service areas.

26. The LBSC of claim 19 wherein the service manager is configured to provide short message service between the first subscriber and the other active subscribers located in one of the plurality of pre-defined service areas.

27. A software product for use in operating a location based service center, the product comprising:
service manager instructions operational when executed by a processor to direct the processor to process a service activation request message from a first subscriber using a wireless device to determine the location of the wireless device relative to one of a plurality of pre-defined service areas that are independent of a communication network, and generate a response message that includes at least one of service area information, venue information, and subscriber information that is based on the location of the wireless device relative to the one of the plurality of pre-defined service areas;
interface system instructions operational when executed by the processor to receive the service activation request message for the service manager and transmit the response message to the wireless device; and
a storage medium operational to store the service manager instructions and the interface system instructions.

28. The product of claim 27 wherein the service manager instructions are operational when executed by the processor to direct the processor to process the service activation request message to activate the communication service for the first subscriber.

29. The product of claim 27 wherein the subscriber information comprises information on other active subscribers.

30. The product of claim 29 wherein the subscriber information comprises profile information on the other active subscribers.

31. The product of claim 30 wherein the profile information on the other active subscribers is generated for the first subscriber based on a first subscriber profile.

32. The product of claim 31 wherein the venue information comprises at least one of events and locations in one of the plurality of pre-defined service areas.

33. The product of claim 32 wherein the at least one of events and locations are generated for the first subscriber based on the first subscriber profile.

34. The product of claim 32 wherein the at least one of events and locations are generated for the first subscriber based on a time of day the first subscriber is located in one of the plurality of pre-defined service areas.

35. The product of claim 32 wherein the at least one of events and locations are generated for the first subscriber based on a season the first subscriber is located in one of the plurality of pre-defined service areas.

36. The product of claim 31 wherein the service area information comprises information on one of the plurality of pre-defined service areas.

37. The product of claim 30 wherein the service manager instructions are operational to provide short message service between the first subscriber and the other active subscribers located in one of the plurality of pre-defined service areas.

38. A method for providing a location based wireless communication service, the method comprising:
defining a group of wireless devices for which a subscriber may request location information;
obtaining location information for at least one wireless device in the defined group;
receiving a request from the subscriber for the location information; and
providing to the subscriber the location of the at least one wireless device and a status of the located at least one wireless device.

39. The method of claim 38 wherein the step of displaying comprises:
displaying on a web-based map the location of the at least one wireless device and the status of the located at least one wireless device.

40. the method of claim 38 comprising:
maintaining profile information for each of the wireless devices within the defined group, wherein the profile information at least includes a rule set defining when and where other subscribers may obtain the location and status of each of the wireless devices.

41. The method of claim 38 the method comprising:
providing short messages between wireless devices within a defined group.

42. A method for providing a location based wireless communication service, the method comprising:
defining a plurality of service areas based on criteria independent of a communication network topology;
receiving a service activation request message from a first subscriber using a wireless device;
processing the service activation request message to obtain the location of the wireless device relative to one of the plurality of service areas; and
providing to the wireless device service area information relating to at least one of the plurality of service areas.

43. The method of claim 42 the method comprising:
providing to the wireless device venue information relating to at least one of activates and events in one of the plurality of service areas.

44. The method of claim 42 the method comprising:
providing to the wireless device subscriber information relating to other subscribers proximately located to the first subscriber.

45. The method of claim 44 wherein the other subscribers are located in at least one of the plurality of service areas.

46. The method of claim 42 the method comprising:
obtaining user information from the first subscriber; and
processing the user information to create a first subscriber profile.

47. The method of claim 44 wherein providing to the wireless device subscriber information comprises:
providing profile information on the other active subscribers.

48. The method of claim 46 wherein providing to the wireless device subscriber information comprises:
processing the first subscriber profile to generate the profile information on the other active subscribers based on the first subscriber profile.

49. The method of claim 42 the method comprising:
putting the other active subscribers in contact with the first subscriber.
